(19) United States
(12) Patent Application Publication
(10) Pub. No.: US 2015/0278618 A1
(43) Pub. Date: Oct. 1, 2015

(54) AUTOMATIC HEAD COUNT DETERMINATION ON BOARD A MEANS OF TRANSPORT

(71) Applicant: Airbus Operations GmbH, Hamburg (DE)

(72) Inventors: Franz Nuscheler, Muenchen (DE); Peter Klose, Hamburg (DE); Matthias Heinisch, Hamburg (DE); Stefan Schneele, Muenchen (DE); Oliver Hanka, Muenchen (DE); Michael Handwerker, Muenchen (DE)

(21) Appl. No.: 14/667,327

(22) Filed: Mar. 24, 2015

(30) Foreign Application Priority Data
Mar. 26, 2014 (EP) 14161682.1

(51) Int. Cl. G06K 9/00; H04N 7/18; B64D 47/08

(52) U.S. Cl. CPC G06K 9/00838; B64D 47/08; H04N 7/181

(57) ABSTRACT

A technique of determining an actual number of passengers on board a means of transport, for example on board an aircraft. A system embodiment comprises a camera arrangement configured to acquire image data on board the means of transport, and a processing unit configured to determine the actual number of passengers on board the means of transport, based on the acquired image data. The camera arrangement comprises at least one of one or more cabin corridor cameras and one or more cabin door cameras. The one or more cabin corridor cameras are configured and arranged to acquire image data of at least one or more cabin corridors of the means of transport. The one or more cabin door cameras are configured and arranged to acquire image data of one or more cabin doors of the means of transport.

### CROSS-REFERENCES TO RELATED APPLICATIONS

This application claims the benefit of the European patent application No. 14161682.1 filed on Mar. 26, 2014, the entire disclosures of which are incorporated herein by way of reference.

### BACKGROUND OF THE INVENTION

The present disclosure generally relates to the field of head count determination. More specifically, the present disclosure relates to a technique of determining an actual number of passengers on board a means of transport, for example on board an aircraft.

Aviation law requires verifying the number of passengers on board an aircraft. Only if the registered and actual number of passengers is identical and verified by the cabin crew, the doors of the aircraft may be closed. Nowadays, the head count of passengers is determined by the cabin crew by means of manual counting. Typically, several crew members count independently to increase reliability of the head count. This requires time, personal and is error-prone which leads to repetitive counting processes until it is verified that the counted number corresponds to the registered number of passengers. Similar processes exist for other means of transport such as cruise liners.

US 2012/0278904 discloses a content presentation system and method allowing content providers to regulate the presentation of content on a per-user-view basis. Content is distributed an associated license option on the number of individual consumers of viewers allowed to consume the content. Consumers are presented with a content selection and a choice of licenses allowing consumption of the content. The users consuming the content on a display device are monitored so that if the number of user-views licensed is exceeded, remedial action may be taken.

DE 41 12 934 A1 relates to a security control system for counting aircraft passengers. In DE 41 12 934, this system is referred to as “PAX GUARD.” According to DE 41 12 934 A1, “PAX GUARD” allows to verify the number of passengers which have passed the gate with the number of passengers which have entered the aircraft. For this purpose, video cameras capture images of passenger seats and it is derived from the captured video images whether a passenger seat is taken by a passenger or not. Thus, in order to reliably detect all passengers on board the aircraft, the passengers must be at their seats.

Thus, the PAX GUARD system fails to reliably determine the number of passengers on board an aircraft.

Accordingly, there is a need for an improved technique for determining an actual number of passengers on board a means of transport, for example on board an aircraft.

### SUMMARY OF THE INVENTION

According to a first aspect, a system for determining an actual number of passengers on board a means of transport, for example on board an aircraft, is provided. The system comprises a camera arrangement and a processing unit. The camera arrangement is configured to acquire image data on board the means of transport, for example on board the aircraft. The processing unit is configured to determine the actual number of passengers on board the means of transport, for example on board the aircraft, based on the acquired image data. The camera arrangement comprises at least one of one or more cabin corridor cameras and one or more cabin door cameras. The one or more cabin corridor cameras are configured and arranged to acquire image data of at least one or more cabin corridors of the means of transport, for example of the aircraft. The one or more cabin door cameras are configured and arranged to acquire image data of one or more cabin doors of the means of transport, for example of the aircraft.

In other words, the camera arrangement comprises (i) one or more cabin corridor cameras configured and arranged to acquire image data of at least one or more cabin corridors of the means of transport, for example of the aircraft, or (ii) one or more cabin door cameras configured and arranged to acquire image data of one or more cabin doors of the means of transport, for example of the aircraft, or (iii) one or more cabin corridor cameras which are configured and arranged to acquire image data of at least one or more cabin corridors of the means of transport, for example of the aircraft, and one or more cabin door cameras which are configured and arranged to acquire image data of one or more cabin doors of the means of transport, for example of the aircraft.

The one or more cabin corridor cameras may be associated with one or more cabin corridors of the means of transport, for example of the aircraft. The one or more cabin corridor cameras may respectively be configured and arranged to at least acquire image data of their associated cabin corridors. For example, a first cabin corridor camera may be associated with a first cabin corridor such that the first cabin corridor camera acquires image data of at least the first cabin corridor. For example, a second cabin corridor camera may be associated with a second cabin corridor such that the second cabin corridor camera acquires image data of at least the second cabin corridor. The one or more cabin corridor cameras may be configured and arranged to acquire image data of further sections of the cabin of the means of transport, for example of the aircraft cabin, in addition to their associated cabin corridors. In consequence, the one or more cabin corridor cameras may respectively be configured and arranged to acquire image data of the whole cabin of the means of transport, for example the whole aircraft cabin, not including the passenger seats. For covering the passenger seats, additional cameras may be provided as will be discussed below.

The one or more cabin door cameras may be associated with one or more cabin doors of the means of transport, for example of the aircraft. The one or more cabin door cameras may respectively be configured and arranged to acquire image data of their associated cabin doors. For example, a first cabin door camera may be associated with a first cabin door such that the first cabin door camera acquires image data of the first cabin door. For example, a second cabin door camera may be associated with a second cabin door such that the second cabin door camera acquires image data of the second cabin door.

The camera arrangement may comprise one or more passenger seat cameras associated with one or more passenger seats of the means of transport, for example of the aircraft. The one or more passenger seat cameras may be being configured and arranged to acquire image data of the associated one or more passenger seats. Each of the one or more passenger seat cameras may be configured and arranged to acquire image data of exactly one associated passenger seat. Alternatively, each of the one or more passenger seat cameras may be configured and arranged to acquire image data of multiple associated passenger seats, e.g., of an associated row of passenger seats.

The one or more passenger seat cameras may be configured and arranged to acquire image data of each passenger seat provided in the means of transport, for example in the aircraft. In this way, each passenger seat in the means of transport, for example in the aircraft, may be covered by the one or more passenger seat cameras.

In case of an aircraft, the one or more passenger seat cameras may be provided in one or more Passenger Service Units, PSUs, provided on board the aircraft. A PSU is an aircraft component which is normally situated above each seat row in the overhead panel above the passenger seats in the cabin of aircraft. Amongst other things a PSU may comprise reading lights, loudspeakers, illuminated signs and automatically deployed oxygen masks and also louvres providing conditioned air. In addition to one or more of the aforementioned elements, one or more passenger seat cameras may be provided in at least a subset of the PSUs provided on board the aircraft.

The system may comprise a control panel to initiate the image data acquisition. In case of an aircraft, the control panel may be part of or be configured as a Flight Attendant Panel (FAP) provided in the aircraft. FAPs are normally installed within the cabin and provide a remote user interface that may be operated by aircraft personnel to control and may monitor various functions around the cabin. After initiation of the image data acquisition, all cameras of the camera arrangement may be instructed to acquire image data in a time-aligned manner, e.g., simultaneously with each other. Subsequent image data acquisition processes may also respectively be time-aligned with each other, e.g., the image data may be acquired simultaneously.

According to a first possible realization of the system according to the first aspect, the camera arrangement may be configured to forward the acquired image data to the processing unit. In accordance therewith, the processing unit may be configured to receive the acquired image data and to determine the actual number of passengers on board the means of transport, for example on board the aircraft, by detecting passengers in the received image data and by adding up the number of detected passengers. In other words, the respective one or more cameras of the camera arrangement—independent of whether cabin corridor cameras and/or cabin door cameras and/or passenger seat cameras are concerned—may forward one or more images actually acquired. In addition, the respective one or more cameras may forward information indicating the camera which actually captured the image(s) so that the processing unit may derive which image has been captured by which camera. The processing unit may receive the forwarded one or more images and may apply certain image processing algorithms in order to detect passengers on the forwarded images. The detected passengers may be summed up by the processing unit in order to arrive at the actual number of passengers.

For example, a first camera such as a cabin corridor camera, may acquire one or more images of a cabin corridor and may forward the acquired one or more images to the processing unit. In addition, a second camera such as a passenger seat camera, which may cover, for example, a row with three passenger seats, may acquire one or more images of the respective three passenger seats and may forward the acquired one or more images to the processing unit. The processing unit may receive the acquired images and may apply suitable image processing algorithms thereto. In this way, the processing unit may determine that, for example, three passengers are present in the cabin corridor (covered by the first camera). Further, the processing unit may determine that, for example, two passengers are present on said passenger seats (covered by the second camera). The processing unit may use these results to determine the actual number of passengers. For example, the processing unit may sum up the number of passengers derived from the image(s) received from and acquired by the first camera, the number of passengers derived from the image(s) received from and acquired by the second camera, and the number of passengers derived from the image(s) received from and acquired by the still further cameras to determine the actual number of passengers on board the means of transport, for example on board the aircraft.

According to a second possible realization of the system according to the first aspect, which may be implemented independent from or in combination with the first possible realization of the system according to the first aspect, the camera arrangement may be configured to detect passengers in the acquired image data. In accordance therewith, the camera arrangement may be configured to forward information indicating the detected passengers to the processing unit. The processing unit may be configured to receive the information indicating the detected passengers and to determine the actual number of passengers on board the means of transport, for example on board the aircraft, by using the received information indicating the detected passengers. In other words, the respective one or more cameras of the camera arrangement—independent of whether cabin corridor cameras and/or cabin door cameras and/or passenger seat cameras are concerned—may apply certain image processing algorithms in order to detect passengers on the acquired images. The one or more cameras may then forward the result of the passenger detection to the processing unit. For example, each of the cameras involved in the passenger detection, may forward whether it has detected a passenger on its corresponding image(s). Each of the cameras involved in the passenger detection may also forward information how many passenger have been detected on its corresponding image(s). The processing unit may receive the forwarded information and may determine the number of passengers by summing up by the received information about the number of passengers.

For example, a first camera such as a cabin corridor camera may acquire one or more images of a cabin corridor and may detect by means of suitable image processing algorithms that three passengers are present in the cabin corridor (covered by the cabin corridor camera). In addition, a second camera such as a passenger seat camera, which may cover, for example, a row with three passenger seats, may acquire one or more images of the respective three passenger seats and may detect by means of suitable image processing algorithms that two passengers are present on said passenger seats. Both the first camera and the second camera may forward their detection results to the processing unit. The processing unit may receive the detection results and may use the received detection results to determine the number of passengers. For example, the processing unit may sum up the number of passengers detected by the first camera, the number of passengers detected by the second camera and the number of passengers detected by still further cameras to determine the actual number of passengers on board the means of transport, for example on board the aircraft.

The processing unit may be configured to compare the determined actual number of passengers on board the means of transport, for example on board the aircraft, to a registered number of passengers. The registered number of passengers may be made available to the processing unit in a number of different ways. For example, the system may comprise an input device configured to receive a user input specifying the registered number of passengers. The input device may be integrated in a control panel, e.g., a FAP, provided in the means of transport, for example in the aircraft. Alternatively or additionally, the system may be connectable to an airline's infrastructure, e.g., to a check-in system, via a data connection in order to receive the registered number of passengers from the infrastructure via the data connection. Such data connection between the system and the infrastructure of the airline handling the respective flight may comprise or be configured as a wireless Gatelink connection. The check-in system may be the check-in system of the airline handling the respective flight.

A mismatch between the determined number of passengers and the registered number of passengers may be signaled to the cabin crew on the control panel. For example, one or more critical sections of the cabin of the means of transport, for example of the aircraft cabin, e.g., one or more sections of the cabin in which there is a mismatch between the determined number of passengers and the registered number of passengers, may be output on the control panel. Such critical sections may comprise one or more seats or seat rows or other sections of the cabin. The counting process may then be restarted manually by the cabin crew or automatically after a predetermined time.

The camera arrangement may comprise one or more infrared cameras. The one or more infrared cameras may be configured and arranged to acquire one or more infrared images of the cabin of the means of transport, for example of the cabin of the aircraft. The infrared cameras may be separate entities different from the one or more cabin corridor cameras, the one or more cabin door cameras and/or the one or more passenger seat cameras. It is, however, also conceivable that the infrared cameras are part of, e.g., are integrated in, the one or more cabin corridor cameras, the one or more cabin door cameras and/or the one or more passenger seat cameras. By additionally considering the image data acquired by the one or more infrared cameras, hidden passengers, e.g., passengers hidden behind certain objects such as components of the cabin of the means of transport, for example, of the aircraft cabin.

The acquired image data may comprise at least one of one or more still images and one or more video images.

Images acquired by the camera arrangement may overlap or not overlap with each other. For example, one or more acquired images may overlap with each other and one or more acquired images may not overlap with each other.

In order to prevent double counting of detected passengers in overlapping sectors (e.g., sectors which may be covered by multiple cameras), at least one of the processing unit and the camera arrangement may be configured to detect such overlapping sectors. By detecting such overlapping sectors, it may be determined that a detected passenger has already been counted, e.g., because one passenger has already been detected in the same section at the same or at least similar time. For example, a first image may include a first area, for example an aircraft galley, and a second image taken by a different camera at the same time may include the same first area, for example the same aircraft galley. In order to prevent that both cameras determine the detection of the same passenger present in the first area, for example in the aircraft galley, at this time, it may be determined that the first area, for example the aircraft galley, is an overlapping section and thus, the detected passenger may only be counted once.

Passengers which have been hidden temporarily by an object or which have been in the lavatory during an initial counting process may be detected in one or more subsequent counting processes. In order to prevent double counting of other passengers during subsequent counting processes, face recognition techniques may be employed in at least one of the camera arrangement and the processing unit.

In general, at least one of the processing unit and the camera arrangement, e.g., one or more cameras of the camera arrangement, may be configured to recognize the faces of the passengers from the acquired image data. The face recognition of passengers may prevent double counting of one and the same passenger. In other words, a face recognition algorithm may store the face of each detected passenger and may, before determining that another passenger is detected, compare the face of a newly detected passenger with the faces already stored. When determining the actual number of passengers on board the means of transport, for example on board the aircraft, by detecting passengers in the received image data, the face recognition algorithm may realize that a detected passenger has already been counted (added to the number of passengers). In this case, the face recognitions algorithm may ensure the already counted passengers is not added again to the number of detected passengers. For example, face recognition of the passengers may be implemented when the one or more cameras capture multiple images or video images (as a series of still images). In this way, even if multiple images of the same passenger are captured, double counting of this passenger will be reliably prevented.

The system may further comprise a passenger information storage device. The passenger information storage device may be configured to store information about the recognized faces of the passengers. The (biometrical) information about the faces of the passengers may be retrieved from or forwarded by the component(s) of the processing unit and/or the camera arrangement responsible for the face recognition. The passenger information storage device may be included in the processing unit. The processing unit may be configured to compare the stored information about the recognized faces of the passengers with passenger information contained in a database. The database may contain passenger information which was previously input and/or collected and/or obtained by other personnel than the crew such as the border patrol, the airline or cruiser personnel and so on. In this way, it can not only be verified that the correct number of passengers is present on board the means of transport, for example on board the aircraft, but that also the correct passengers are present on board the means of transport, for example on board the aircraft. For example, the detected face of a passenger as stored in the passenger information storage device may be compared with biometrical passport data as stored in the database. If there is a match, e.g. the recognized face belongs to passport data contained in the database, it can be concluded that the detected passenger is allowed to be present on board the means of transport, for example on board the aircraft.

The system may further comprise a safety belt detection arrangement by means of which it may be checked whether the safety belts of at least the determined and registered passengers are closed.

According to a second aspect, a method for determining an actual number of passengers on board a means of transport, for example on board an aircraft, is provided. The method comprises the steps of acquiring image data on board the means of transport, for example on board the aircraft, by means of a camera arrangement and determining the actual number of passengers on board the means of transport, for example on board the aircraft, based on the acquired image data. The step of acquiring image data comprises at least one of acquiring image data of at least one or more cabin corridors of the means of transport, for example of the aircraft, by means of one or more cabin corridor cameras, and acquiring image data of one or more cabin doors of the means of transport, for example of the aircraft, by means of one or more cabin door cameras.

The step of acquiring image data may comprise acquiring image data of one or more passenger seats by means of one or more passenger seat cameras.

According to a third aspect, a computer program product is provided. The computer program product comprises program code portions for carrying out one or more of the steps of any one of the method aspects described herein, when the computer program product is run or executed on a computer system or on one or more computing devices (e.g., a microprocessor, a microcontroller or a digital signal processor (DSP)). The computer program product may be stored on a computer-readable recording medium, such as a permanent or rewritable memory.

All of the above described aspects may be implemented by hardware circuitry and/or by software.

Even if some of the above aspects are described herein with respect to the processing unit, the camera arrangement or the system comprising the processing unit and the camera arrangement, these aspects may also be implemented as a method or as a computer program for performing or executing the method. Likewise, aspects described as or with reference to a method may be realized by suitable units in the processing unit, the camera arrangement, the system comprising the processing unit or by means of the computer program.

### BRIEF DESCRIPTION OF THE DRAWINGS

In the following, the present disclosure will further be described with reference to exemplary embodiments illustrated in the figures, in which:

FIG. 1 schematically illustrates an embodiment of a system for determining an actual number of passengers on board an aircraft;

FIG. 2a schematically illustrates a first variant of a method embodiment performed in the system of FIG. 1;

FIG. 2b schematically illustrates a second variant of a method embodiment performed in the system of FIG. 1;

FIG. 3 illustrates a passenger service unit in which a camera is integrated;

FIG. 4 schematically illustrates a second embodiment of a system for determining an actual number of passengers on board an aircraft;

FIG. 5a schematically illustrates a first variant of a method embodiment performed in the system of FIG. 4;

FIG. 5b schematically illustrates a second variant of a method embodiment performed in the system of FIG. 4; and

FIG. 6 schematically illustrates a method embodiment performed in the system of FIG. 1 or FIG. 4.

### DETAILED DESCRIPTION OF THE PREFERRED EMBODIMENTS

In the following description, for purposes of explanation and not limitation, specific details are set forth in order to provide a thorough understanding of the present disclosure. It will be apparent to one skilled in the art that the present disclosure may be practiced in other embodiments that depart from these specific details. Although the embodiments described below are only explained with respect to an aircraft to illustrate the present disclosure, the present disclosure is not limited to aircrafts but can be implemented in other means of transport, for example means of transport with similar boarding processes and/or check-in systems as aircraft such as cruise liners. For example, the skilled person will appreciate that the present disclosure may be practiced with other configuration than the specific number and arrangement of passenger seats discussed below to illustrate the present disclosure. Even if in the below the present disclosure is described only with respect to a single cabin corridor camera and a single cabin door camera, the disclosure may equally be practiced in an environment having multiple cabin corridor cameras and/or multiple cabin door cameras, e.g., one for each cabin corridor and/or one for each cabin door, respectively.

Those skilled in the art will further appreciate that functions explained hereinbelow may be implemented using individual hardware circuitry, using software functioning in conjunction with a programmed microprocessor or a general purpose computer, using an application specific integrated circuit (ASIC) and/or using one or more digital signal processors (DSPs). It will also be appreciated that when the present disclosure is described as a method, it may also be embodied in a device (i.e., the one or more cameras, the processing unit and/or the system comprising the processing unit described below), a computer processor and a memory coupled to a processor, wherein the memory is encoded with one or more programs that perform the methods disclosed herein when executed by the processor.

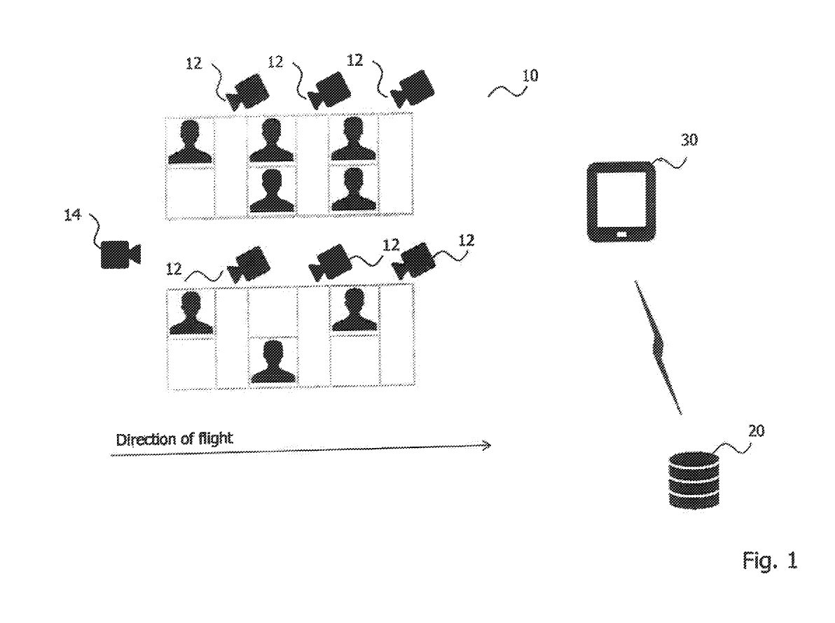

FIG. 1 schematically illustrates a first embodiment of a system for determining an actual number of passengers on board an aircraft. Further, FIG. 1 shows a section of an aircraft in which, by way of example, a cabin corridor as well as six passenger seats on the right side of the cabin corridor (right side, when looking into the direction of flight) and six passenger seats on the left side of the cabin corridor are arranged (left side, when looking into the direction of flight). The right and left sides are separated by the cabin corridor.

The system comprises a camera arrangement 10 and a (central) processing unit 20. Further, by way of example, the system comprises a control panel 30 which is, in the exemplary configuration shown in FIG. 1, configured as a Flight Attendant Panel (FAP) 30. The camera arrangement 10 comprises, by way of example, seven cameras to illustrate that any number of cameras may be provided in the system. In more detail, the camera arrangement 10 comprises one cabin corridor camera 14 which is configured and arranged to acquire (capture) images of a cabin corridor within the aircraft and corresponding image data. Further, six passenger seat cameras 12 are shown by way of example. It is, however, conceivable that the system is implemented without any passenger seat cameras 12. As exemplarily shown in FIG. 1, each of the six passenger seat cameras 12 covers a respective set of passenger seats. According to FIG. 1, each passenger seat camera 12 covers one row of each side of the cabin corridor. In the example of FIG. 1, two seats are covered by each passenger seat camera 12. However, it is equally possible that each passenger seat camera 12 covers exactly one passenger seat, or more seats per row (e.g., if a row comprises more seats), or even seats of multiple rows.

In the system of FIG. 1, the FAP 30 is connected to each camera, i.e., each of the six passenger seat cameras 12 and the cabin corridor camera 14, by means of a wired connection and to the processing unit 20 by means of a wireless connection.

By way of example, five seats on the right side of the cabin corridor are taken and one is empty. On the left side of the cabin corridor, three passenger seats are taken and three are empty, i.e., one in each row is empty and one in each row is taken. Corresponding image data is acquired by the passenger seat cameras 12. More specifically, each of the passenger seat cameras 12 on the right side respectively is configured and arranged to acquire one or more images of the respective passenger seats they cover. Each of the passenger seat cameras 12 on the left side respectively acquires one or more images of the respective passenger seats they cover.

In conventional systems, it may be concluded that eight passengers are present in the section of the aircraft shown in FIG. 1. However, if one or more passengers are currently in the cabin corridor or hidden by other passengers or obstacles while the passenger seat cameras 12 acquire images, these passengers cannot be detected although they are on board the aircraft.

In order to more reliably determine the actual number of passengers present on board the aircraft, the first embodiment of the system comprises the cabin corridor camera 14. The cabin corridor camera 14 is arranged in the aircraft to cover the cabin corridor, i.e., the view of the cabin corridor camera 14 at least covers a section of the cabin corridor, and is configured to acquire one or more images of the cabin corridor. If it is assumed that that an additional passenger is not seated but rather is present in the cabin corridor, the system can correctly assume that nine passengers are present in the illustrated section of the aircraft.

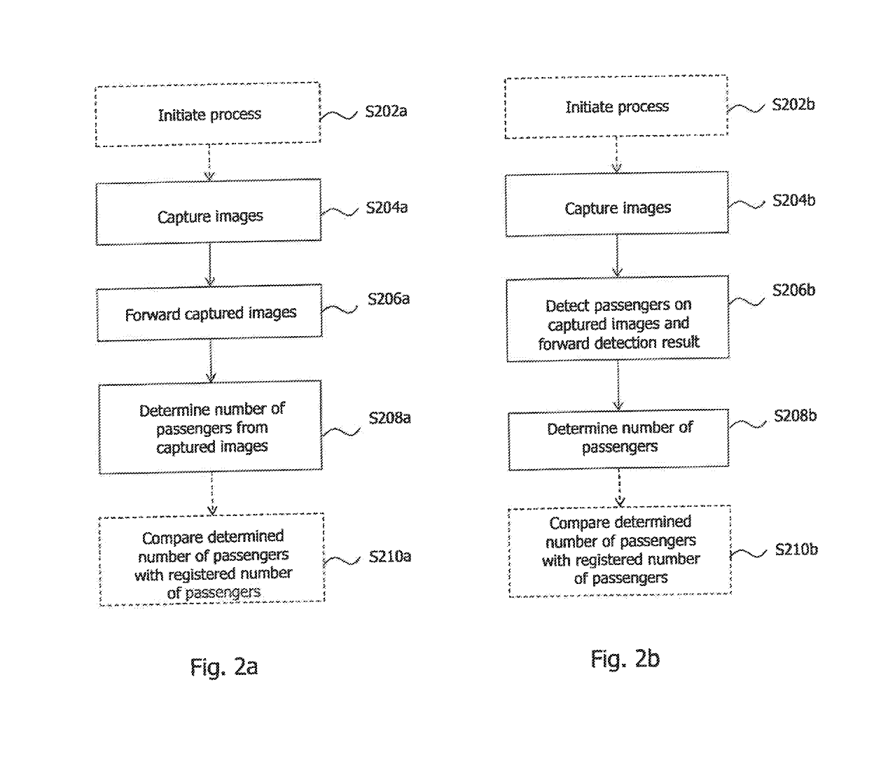

Two variants of method embodiments for determining the number of passenger number by means of the system of FIG. 1 will be explained in the following with respect to FIGS. 2a and 2b.

According to the first variant shown in FIG. 2a, the head count determination process may be initiated by a crew member on the FAP 30 in a first optional step S202a. The head count determination process may be started after boarding or during the boarding process. In step S204a, the passenger seat cameras 12 and the cabin corridor camera 14 respectively acquire one or more images as image data. Then, in step S206a, the passenger seat cameras 12 and the cabin corridor camera 14 respectively forward the acquired image data to the FAP 30, which itself transmits the acquired image data (wirelessly) to the processing unit 20. The processing unit 20 applies image processing algorithms on the received images. The processing unit 20 is able to determine which image(s) is/are associated with (have been captured by means of which) camera. By means of the image processing algorithms applied, the processing unit 20 detects, for the image(s) of each camera, whether a passenger is present or not. The number of detected passengers is summed up by the processing unit 20 to determine the actual overall number of passengers (step S208a). In order to prevent double counting of passengers, e.g. in overlapping images, face recognition algorithms may be applied by the processing unit 20. For example, faces of newly detected passengers are compared with faces of already detected passengers and the number of passengers is only increased if the face of a newly detected passenger does not match the face of any previously detected passenger. In a further optional step S210a, the processing unit 20 compares the determined number of passengers with a registered number of passengers, i.e., the number of passengers which has been previously stored/registered in the system. The registered number of passengers may be input be the cabin crew into the FAP 30 or may be retrieved from the check-in system of the airline.

With reference to the specific exemplary arrangement of FIG. 1, each of the passenger seat cameras 12 and the cabin corridor camera 14 acquires one or more images and forwards the one or more images to the FAP 30, which itself forwards the image data to the processing unit 20. Based on the one or more images as taken by each of the passenger seat cameras 12 and the cabin corridor camera 14, the processing unit 20 determines that there is one passenger in the first row on the right side, that there are two passengers in the middle row on the right side and that there are two passengers in the last row on the right side. The processing unit 20 further determines that there is one passenger in each row on the left side. Still further, the processing unit 20 determines whether and, if to the affirmative, how many passengers are present in the image(s) taken by the cabin corridor camera 14. The processing unit 20 then sums up the number of detected passengers so as to determine the total number of passengers on board the aircraft.

According to the second variant shown in FIG. 2b, the head count determination process may be initiated by a crew member on the FAP 30 in a first optional step S202b. Then, each of the passenger seat cameras 12 and the cabin corridor camera 14 acquires one or more images as image data (step S204b). In step S206b, each of the cameras, i.e., each of the passenger seat cameras 12 and the cabin corridor camera 14, applies image processing algorithms to detect whether a passenger is present in the acquired image(s). In order to prevent double counting of passengers, e.g. in overlapping images, face recognition algorithms may be applied by the cameras 12, 14. For example, faces of newly detected passengers are compared with faces of already detected passengers and the number of passengers is only increased if the face of a newly detected passenger does not match the face of any previously detected passenger. After determining whether a passenger is present in the image(s) or not, the cameras 12, 14 forward their determination results to the FAP 30. The determination result may, in a simple version, comprise information whether a camera has detected a passenger and, if to the affirmative, how many passengers have been detected by the respective camera 12, 14. The FAP 30 wirelessly transmits the determination results to the processing unit 20. The processing unit 20 then simply sums up the detection results of each camera 12, 14 in order to determine the number of passengers (step S208b). In a further optional step S210b, the determined number of passengers is compared with a registered number of passengers, i.e., the number of passengers which has been previously stored/registered in the system. The registered number of passengers may be input be the cabin crew into the FAP 30 or may be retrieved from the check-in system of the airline.

If it is, for example determined that the determined number of passengers does not match the registered number of passengers, e.g., the number of checked-in passengers, this may be signaled to the cabin crew on the FAP 30, for example. For example, one or more critical sections of the aircraft cabin in the sense of one or more sections of the cabin in which there is a mismatch (e.g., too few or too many passengers) between the determined number of passengers and the registered number of passengers may be output on the FAP 30. Such critical sections may be certain seat rows or seats of the aircraft. The counting process can then be restarted manually by the cabin crew, and/or the acquired images may be output on the FAP 30 on demand and/or the critical sections can be inspected manually.

With reference to FIG. 1, each of the passenger seat cameras 12 on the right side of the cabin corridor acquires one or more images and determines therefrom that there is one passenger in the first row, that there are two passengers in the second (middle) row and that there are two passengers in the last row. Further, each of the passenger seat cameras 12 on the left side of the cabin corridor acquires one or more images and determines therefrom that there is one passenger per row. Still further, the cabin corridor camera 14 acquires one or more images and derives therefrom the number of passengers in its view (in the cabin corridor). All of these cameras, i.e., each of the passenger seat cameras 12 and the cabin corridor camera 14, forward their results, i.e., the detected number of passengers, to the FAP 30 which transmits said information to the processing unit 20. The processing unit 20 sums up the number of passengers as determined by each camera 12, 14 so as to determine the total number of passengers on board the aircraft.

In addition to the above, e.g., in addition to each of the aforementioned variants, one or more of the passenger seat cameras 12 and/or the cabin corridor camera 14 can be equipped with an infrared camera (not shown). It is also conceivable that infrared cameras can be provided as separate entities. Independent of whether separate infrared cameras are provided or whether the infrared cameras are part of the one or more passenger seat cameras 12 and/or the cabin corridor camera 14, hidden passengers can be detected by means of the infrared cameras. For example, passengers hidden by certain objects such as newspapers, seats or (opened) overhead compartments can be detected. This increases reliability of the system even more.

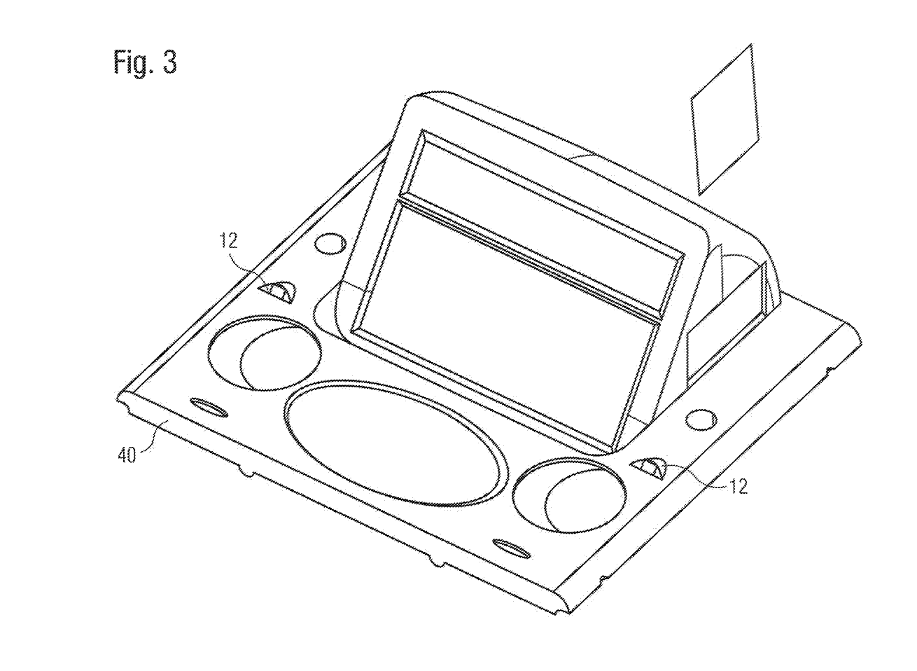

FIG. 3 shows an exemplary configuration of how two passenger seat cameras 12 can be integrated into a passenger service unit (PSU) 40. Although two passenger seat cameras 12 are shown by way of example, any number of passenger seat cameras 12 may be integrated per PSU 40.

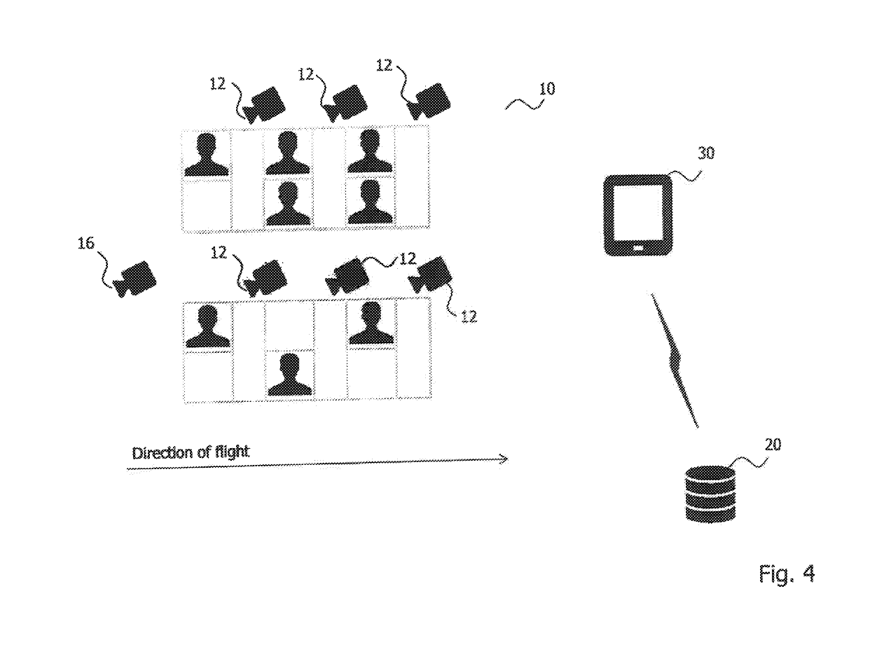

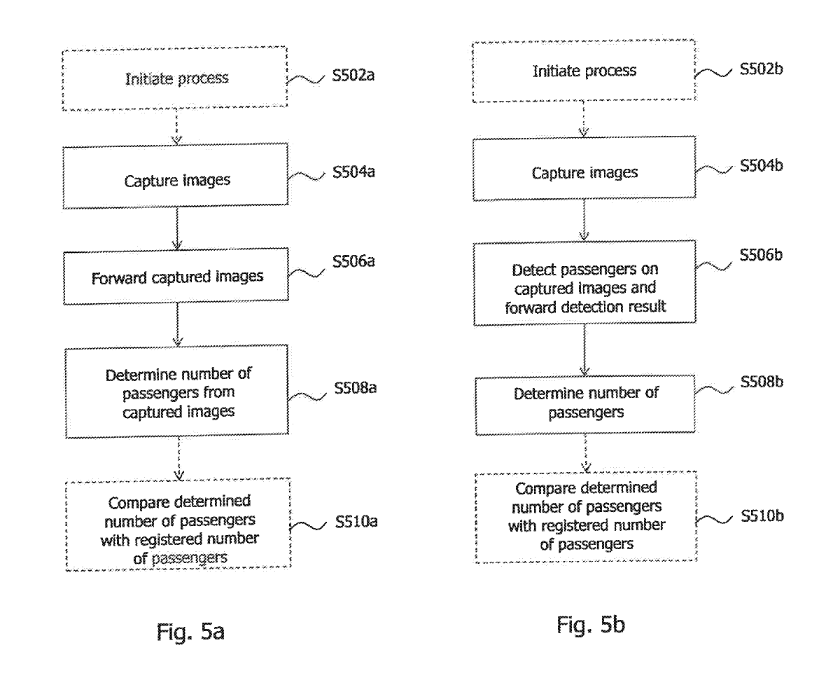

FIG. 4 schematically shows a second embodiment of a system for determining the actual number of passengers on board an aircraft. The only difference between the second embodiment of the system shown in FIG. 4 and the first embodiment of the system shown in FIG. 1 is that, instead of the cabin corridor camera 14, a cabin door camera 16 is provided. Thus, all other aspects and details explained above with respect to first embodiment (and the first and second variants as explained with respect to FIGS. 2a and 2b) equally apply to the second embodiment of FIG. 4 and the corresponding method variants of FIGS. 5a and 5b as well.

The cabin door camera 16 is configured and arranged to acquire one or more images of a cabin door of the aircraft as image data. Although only one cabin door camera 16 is shown in FIG. 4, there may be plural cabin door cameras 16 per cabin door, or, in case of multiple cabin doors, multiple cabin door cameras 16 on board the aircraft, e.g., one for each door. As a variant of the second embodiment, both one or more cabin door cameras 16 and one or more cabin corridor cameras 14 may be provided. In addition, passenger seat cameras 12 may be provided or not.

According to a first variant of a method embodiment shown in FIG. 5a, which can be performed by the system of FIG. 4, the head count determination process may be initiated by a crew member on the FAP 30 in a first optional step S502a. The head count determination process may be started during the boarding process. In step S504a, the passenger seat cameras 12 and the cabin door camera 16 respectively acquire one or more images as image data. The acquired image data is forwarded to the FAP 30 and transmitted to the processing unit 20 (step S506a). The processing unit 20 applies image processing algorithms on the received images. The processing unit is able to determine which image(s) are associated with (have been captured by means of which) camera. By means of the image processing algorithms applied, the processing unit 20 detects, for the image(s) of each camera, whether a passenger is present or not. The number of detected passengers is summed up by the processing unit to determine the actual overall number of passengers (step S508a). Based on the one or more images as taken by each of the passenger seat cameras 12 and the cabin door camera 16, the processing unit 20 determines that there is one passenger in the first row on the right side, that there are two passengers in the middle row on the right side and that there are two passengers in the last row on the right side. The processing unit 20 further determines that there is one passenger in each row on the left side. Still further, the processing unit 20 determines, from the image(s) taken by the cabin door camera 16, whether and, if to the affirmative, how many passengers are entering the cabin door. Again, face recognition algorithms may be applied. In a further optional step S510a, the determined number of passengers is compared with a registered number of passengers, i.e., the number of passengers which has been previously stored/registered in the system. The registered number of passengers may be input be the cabin crew into the FAP 30 or may be retrieved from the check-in system of the airline.

According to a second variant of a method embodiment shown in FIG. 5b, which can be performed by the system of FIG. 4, the head count determination process may be initiated by a crew member on the FAP 30 in a first optional step S502b. Then, each of the passenger seat cameras 12 and the cabin door camera 16 acquires one or more images as image data (step S504b). In step S506b, each of the cameras, i.e., each of the passenger seat cameras 12 and the cabin corridor camera 16, applies image processing algorithms to detect whether a passenger is present in the acquired image(s). With reference to FIG. 4, each of the passenger seat cameras 12 on the right side of the cabin corridor acquires one or more images and determines therefrom that there is one passenger in the first row, that there are two passengers in the second (middle) row and that there are two passengers in the last row. Further, each of the passenger seat cameras 12 on the left side of the cabin corridor acquires one or more images and determines therefrom that there is one passenger per row. Still further, the cabin door camera 16 acquires one or more images and derives therefrom the number of passengers in its view (around the cabin door). For example, the cabin door camera 16 determines that no further passengers have entered the aircraft (example 1) or that two further passengers have entered the aircraft through the cabin door (example 2).

All of these cameras, i.e., each of the passenger seat cameras 12 and the cabin door camera 16, forward their results, i.e., the detected number of passengers, to the FAP 30 which transmits said information to the processing unit 20. Again, face recognition algorithms may be applied to prevent double counting. After having received the determination results of the cameras 12, 16, the processing unit 20 simply sums up the detection results of each camera 12, 16 in order to determine the number of passengers (step S508b). In accordance with example 1, the processing unit 20 determines that 8 passengers are on board the aircraft (five on the right side of the cabin corridor, three on the left side of the cabin corridor and zero that have additionally entered the aircraft). In accordance with example 2, the processing unit 20 determines that 10 passengers are on board the aircraft (five on the right side of the cabin corridor, three on the left side of the cabin corridor and two that have additionally entered the aircraft). In a further optional step S510b, the determined number of passengers is compared with a registered number of passengers, i.e., the number of passengers which has been previously stored/registered in the system. The registered number of passengers may be input be the cabin crew into the FAP 30 or may be retrieved from the check-in system of the airline.

In short, when the first variant explained above is applied, the cabin door camera 16 just forwards the images and the processing unit 20 determines the number of passengers from said images. When the second variant is applied, the cabin door camera 16 sums up the number of detected passengers and forwards the determined number to the processing unit 20. Alternatively, the cabin door camera 16 informs the processing unit 20 upon detection of a new passenger and the summation of the number of detected passengers is then performed in the processing unit 20. Independent of the exact realization, the number of all passengers having entered the aircraft can be reliably determined.

According to one option, the system only comprises one or more cabin door cameras 16 without any passenger seat cameras 12 and cabin corridor cameras 14.

Alternatively, the system comprises one or more cabin door cameras 16 and additionally one or more cabin corridor cameras 14 and/or one or more passenger seat cameras 12. In this case, the camera(s) of one of the camera types may be used as the main camera(s) on the basis of which the number of passengers is determined as described above. One or more of the camera(s) of the other camera types may then be used as (a) backup camera(s), on the basis of which the number of passengers is checked.

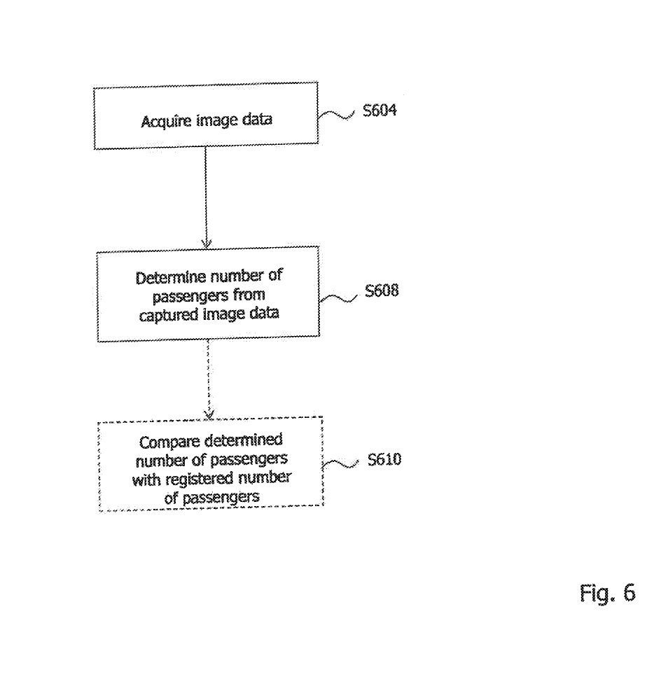

The common parts of the method variants of FIGS. 2a, 2b, 5a and 5b are summarized briefly below and shown in FIG. 6. In other words, FIG. 6 shows a method embodiment which is in line with the specific method variants of FIGS. 2a, 2b, 5a and 5b. Thus, the method embodiment of FIG. 6 can be implemented in both system embodiments of FIGS. 1 and 4. The method of FIG. 6 comprises acquiring, in step S604, image data on board the aircraft by means of a camera arrangement 10 and determining, in step S608, the actual number of passengers on board the aircraft based on the acquired image data. The step of acquiring image data comprises at least one of (i) acquiring image data of at least one or more cabin corridors of the aircraft by means of one or more cabin corridor cameras 14, and (ii) acquiring image data of one or more cabin doors of the aircraft by means of one or more cabin door cameras 16. In an optional step S610, the determined number of passengers may be compared with the registered number of passengers.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A system for determining an actual number of passengers on board a means of transport, the system comprising:
a camera arrangement configured to acquire image data on board the means of transport; and
a processing unit configured to determine the actual number of passengers on board the means of transport based on the acquired image data;
wherein the camera arrangement comprises at least one of:
one or more cabin corridor cameras configured and arranged to acquire image data of at least one or more cabin corridors of the means of transport, and
one or more cabin door cameras configured and arranged to acquire image data of one or more cabin doors of the means of transport.

2. The system of claim 1, wherein the camera arrangement comprises one or more passenger seat cameras associated with one or more passenger seats of the means of transport, the one or more passenger seat cameras being configured and arranged to acquire image data of the associated one or more passenger seats.

3. The system of claim 2, wherein the one or more passenger seat cameras are configured and arranged to acquire image data of each passenger seat provided in the means of transport.

4. The system of claim 2, wherein the one or more passenger seat cameras are provided in one or more Passenger Service Units, PSUs, provided on board the means of transport.

5. The system of claim 1, wherein the camera arrangement is configured to forward the acquired image data to the processing unit, and the processing unit is configured to receive the acquired image data and to determine the actual number of passengers on board the means of transport by detecting passengers in the received image data and by adding up the number of detected passengers.

6. The system of claim 1, wherein the camera arrangement is configured to detect passengers in the acquired image data and to forward information indicating the detected passengers to the processing unit, and the processing unit is configured to receive the information indicating the detected passengers and to determine the actual number of passengers on board the means of transport by using the received information indicating the detected passengers.

7. The system of claim 1, wherein the processing unit is configured to compare the determined actual number of passengers on board the means of transport to a registered number of passengers.

8. The system of claim 7, wherein the system further comprises an input device configured to receive a user input specifying the registered number of passengers.

9. The system of claim 7, wherein the system is connectable to an infrastructure of an airline via a data connection and to receive the registered number of passengers from the infrastructure via the data connection.

10. The system of claim 1, wherein the camera arrangement comprises one or more infrared cameras, the one or more infrared cameras being configured and arranged to acquire one or more infrared images of the cabin of the means of transport.

11. The system of claim 1, wherein at least one of the processing unit and the camera arrangement is configured to recognize the faces of the passengers from the acquired image data.

12. The system of claim 11, wherein the system further comprises a passenger information storage device configured to store information about the recognized faces of the passengers, and the processing unit is configured to compare the stored information about the recognized faces of the passengers with passenger information contained in a database.

13. The system of claim 1, wherein the system comprises a control panel to initiate the image data acquisition.

14. The system of claim 1, wherein the acquired image data comprises at least one of one or more still images and one or more video images.

15. The system of claim 1, wherein the means of transport comprises an aircraft.

16. A method for determining an actual number of passengers on board a means of transport, the method comprising the steps of:
acquiring image data on board the means of transport, by means of a camera arrangement; and
determining the actual number of passengers on board the means of transport, based on the acquired image data;
wherein the step of acquiring image data comprises at least one of
acquiring image data of at least one or more cabin corridors of the means of transport, by means of one or more cabin corridor cameras, and
acquiring image data of one or more cabin doors of the means of transport, by means of one or more cabin door cameras.
